(19) United States
(12) Patent Application Publication
(10) Pub. No.: US 2007/0156541 A1
(43) Pub. Date: Jul. 5, 2007

(54) Beauty care product selling aid and method for facilitating the selling of a beauty care product

(76) Inventors: Tanya Nicole Blasko, Cincinnati, OH (US); Michael Warren Goodman, Cincinnati, OH (US); Leigh Boudreau Radford, Cincinnati, OH (US); Michelle Christina Thompson, Cincinnati, OH (US); Stacy Alycia Thomas, Chicago, IL (US); Christina Ellen Bautista, Cincinnati, OH (US); Kimberly Dawn Roberts, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/326,248

(22) Filed: Jan. 5, 2006

(51) Int. Cl. G06Q 30/00

(52) U.S. Cl. 705/26

(57) ABSTRACT

A method for facilitating the selling of a beauty care product comprising the step of portraying a first image or image region to communicate skin appearance before using the beauty care product, and portraying a second image or image region to communicate skin appearance after using the beauty care product. The second image or image region appears to have a relatively higher resolution or clarity than the first image or image region.

### FIELD OF THE INVENTION

The present invention is directed to beauty care product selling aids, methods for facilitating the selling of a beauty care product, and methods for merchandising beauty care products.

### BACKGROUND OF THE INVENTION

The number of different beauty care products being offered for sale at any one location can be overwhelming to prospective buyers. For example, there can be over a hundred different products from which to choose. Furthermore, manufacturers of beauty care products typically utilize text to communicate various aspects of their products to prospective buyers, such as, the contents of the product, the recommended usage of the product, and the purported benefits of using the product. Reading and understanding the text associated with a single product or multiple products for comparison purposes can be burdensome. Moreover, many consumers may find it easier to relate to pictures or illustrations rather than simply text, as noted by the oft-cited phrase “a picture is worth a thousand words.”

Beauty care products are also typically adorned with colors, graphics, or other indicia/ornamentation to simplify repeat purchases. However, these indicia do not necessarily provide important information about the product for an initial purchase decision or for allowing consumers to compare competing products.

Accordingly, there is a need for selling aids and techniques that can effectively and conveniently communicate consumer-important aspects associated with beauty care products.

### SUMMARY OF ILLUSTRATIVE EMBODIMENTS

The present invention is directed to beauty care selling aids. At least some of the beauty care selling aids comprise a tangible medium of expression, and one or more images fixed in and portrayable from the tangible medium of expression. In accordance with one exemplary embodiment, there has now been provided a beauty care product selling aid comprising a tangible medium of expression and two or more images fixed in the tangible medium of expression. The two or more images depict a visual transformation in skin appearance, from a first appearance before using the beauty care product to a second appearance after using the beauty care product, through the use of pixels that are individually discernable with the naked eye, and/or modification thereof.

Preferred beauty care product selling aids include primary and/or secondary packaging; product brochures, inserts or pamphlets; store displays, and printed documents included in magazines, newspaper or other periodical that communicate a visual transformation in skin appearance that may occur by using the beauty care product.

The present invention is also directed to methods for facilitating the selling of a beauty care product. At least some of the methods comprise the step of communicating a visual transformation in skin appearance that may occur by using the beauty care product. The step of communicating is preferably done by portraying one or more images or image regions to illustrate the visual transformation. For example, and in accordance with one exemplary embodiment, there has now been provided a method for facilitating the selling of a beauty care product comprising the step of portraying a first image or image region to communicate skin appearance before using the beauty care product, and portraying a second image or image region to communicate skin appearance that may be attainable after using the beauty care product for a period of time sufficient to provide a similar appearance change of one's skin. The second image or image region appears to have a relatively higher resolution or clarity than the first image or image region.

Methods of merchandising beauty care products are also provided by the present invention. The methods of merchandising comprise the step of communicating to prospective buyers of beauty care products a comparison between a first beauty care product that utilizes features of the present invention on packaging of the first beauty care product and/or in images associated with the sale of the first beauty care product, and a second beauty care product that does or does not utilize these same features.

The beauty care product selling aids and methods provided by the present invention can provide real-world value to consumers. Consumers can quickly and easily ascertain, when faced with a plethora of product options, that the beauty care product associated with the selling aids and methods herein are for improving the appearance of skin. The visual contrast portrayed by the selling aids and methods can communicate the transformation from a first skin appearance to a second skin appearance, with the second skin appearance being one of higher definition, or being flawless and/or luminous, for example. The selling aids and methods can be useful to consumers for a variety of reasons. For example, the selling aids and methods provide improved communication about the associated beauty care product and its intended benefit for consumers that prefer to relate to images/pictures rather than text to understand communicated concepts or ideas. The selling aids and methods may also shorten the amount of time a consumer needs to make a purchasing decision when facing numerous options because the visual imagery of the claimed invention may communicate aspects of the associated beauty care product quicker than text alone.

### BRIEF DESCRIPTION OF THE DRAWINGS

While the specification concludes with claims particularly pointing out and distinctly claiming the subject matter which is regarded as forming the present invention, it is believed that illustrative embodiments of the present invention may be better understood from the following description taken in conjunction with the accompanying drawings, in which:

FIG. 1 shows an image of a human's face that includes two regions of varying resolution.

FIG. 2 shows a collection of pixels that are discernable with the naked eye.

FIG. 3 shows the collection of pixels shown in FIG. 2 in a multiplied and overlaying arrangement.

FIG. 4 shows a non-skin image including three interconnecting triangles, with two of the three triangles containing pixels that are discernable with the naked eye.

FIG. 5 shows an image of a human's face that includes a first region and a second region, wherein the second region is portrayed as having a lighter, brighter or illuminated appearance relative to the first region.

FIG. 6A shows an image including a portion of a human face and pixels that appear to be projecting into the human face.

FIG. 6B shows an image including a plurality of pixels that appear to be projecting into the image and a series of counting references to communicate a level or depth of penetration.

FIG. 7 shows a first image of a human's face and a second image of the face, wherein the second image appears lighter, brighter or illuminated relative to the first image.

FIG. 8 shows two images that include a portion of a human face, wherein the first image includes relatively dark shaded pixels and the second image includes relatively light shaded pixels.

FIG. 9 shows two images that include a portion of a human face, wherein the first image includes pixels that are discernable with the naked eye and the second image is substantially devoid of the pixels.

FIG. 10 shows a trilogy of images, a first image to communicate skin appearance before using a particular beauty care product, a second image to communicate skin appearance after an initial use of the product, and a third image to communicate skin appearance after repeated uses of the product.

FIG. 11 shows two beauty care products, the first beauty care product includes pixels disposed on its primary packaging and the second beauty care product includes both pixels and a textual comparison to the first beauty care product disposed on its primary packaging.

### DETAILED DESCRIPTION OF ILLUSTRATIVE AND PREFERRED EMBODIMENTS

It is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural.

The present invention is directed to beauty care product selling aids. The selling aids include a tangible medium of expression and one or more images fixed in the medium. As used herein, the term “fixed” and the phrase “tangible medium of expression” is defined in accordance with the 1976 Copyright Act and judicial interpretations of the same. Depending on the form of the tangible medium of expression, the images may be portrayable with or without peripheral devices.

A printed substrate is one exemplary form of the tangible medium of expression. The adjective “printed” should not to be construed as a limitation on how images are fixed in this exemplary tangible medium of expression, but instead is being used as a generic term that includes all means known to fix an image in or on a substrate.

The printed substrate can be employed as part of (or all of) the primary and/or secondary packaging of a beauty care product. “Primary packaging,” as used herein, means any container in which the beauty care product is in direct contact. And “secondary packaging” means any additional materials that are associated with the primary packaging, such as, for example, a box or polymeric sleeve that at least partially surrounds the primary packaging.

The printed substrate may also be a brochure, instruction sheet, or other informative document that is associated with the beauty care product. Although not required by the present invention, these documents are typically included in or attached to packaging materials.

A tangible advertisement is another example of a printed substrate, including, for example, a page in a magazine or newspaper, a sticker, a coupon, a flyer, an in-aisle or end-of-aisle display, and point-of-sale items intended to either be taken by prospective buyers or remain in an area proximate the beauty care product. Printed substrates other than those described herein can equally be employed in accordance with the present invention.

Data memory devices are another exemplary form of the tangible medium of expression. A representative, non-limiting list of data memory devices includes computer hard drives, disks, CD's, diskettes, memory cards, and chips. Video tapes are also suitable as the tangible medium of expression. The tangible medium of expression further includes any other medium that is capable of being embedded or encoded with portrayable images.

The images fixed in the tangible medium of expression are intended to communicate a visual transformation in skin appearance that might occur by using an associated beauty care product. As used herein, the term “image” means any visual representation of an object. A single image, as well as multiple images, may be used in accordance with embodiments of the present invention. When multiple images are employed, the individual images may be portrayed separately or together with one or more of the multiple images. Images portrayed together may be in contact with or spaced apart from one another.

The images may include a photograph of human skin. The photograph may optionally be altered to simulate various skin imperfections, such as, for example, brown spots, discolorations, fine lines, wrinkles, uneven tone and/or texture, dullness, and dark circles. Optional alterations may also be used to simulate improvements in simulated or actual skin imperfections. The images may include an illustration of human skin. Images showing actual or illustrated skin are preferably associated with a consumer's face, neck, chest, or hand. Skin images however may be taken from other body parts. In alternate embodiments, the images do not include actual or illustrated skin, but instead comprise indicia, graphics, pictures, or other visual representations of non-skin objects to visually convey the idea of skin transforming from one appearance to another appearance through use of a particular beauty care product.

The present invention is also directed to methods for facilitating the selling of beauty care products. Preferred methods comprise the step of portraying one or more images to visually communicate or convey a transformation in skin appearance that may occur through use of the beauty care product. Preferred beauty care products are targeted to reverse the manifestations of age and past damage, and to effect a more defined, luminous, and virtually flawless appearance. These products are typically marketed to improve fine lines, wrinkles, and/or skin discolorations (e.g., brown spots and dullness). It is to be understood that the selling aids and methods of the present invention however are not limited to a specific type/form of beauty care product or a specific targeted benefit(s).

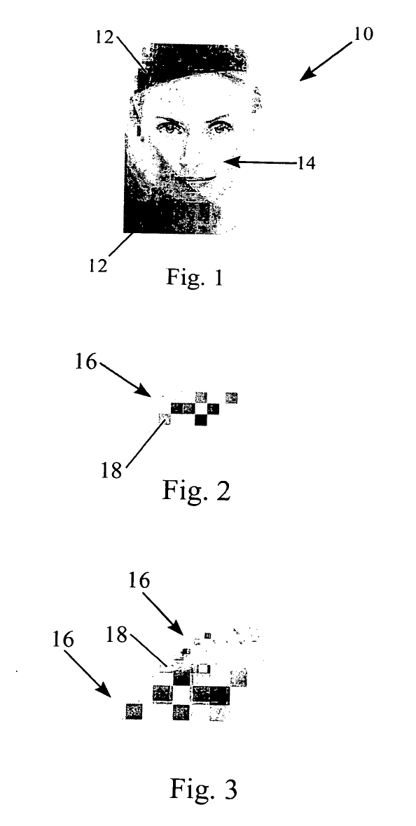

Exemplary images will now be discussed. The various features manifested in the images can be used alone or in combination with shown and non-shown features. Referring now to FIG. 1, an image 10 is shown that includes a woman's face defined by a first region 12 and a second region 14. Second region 14 is depicted with a relatively higher resolution or clarity compared to first region 12. For example, an observer of image 10 may describe first region 12 as being blurry, out-of-focus, or grainy relative to second region 14, or describe second region 14 as crisp, less grainy, having higher definition, or focused relative to first region 12. The relative difference in resolution between regions 12 and 14 is intended to communicate an improvement in skin appearance that may occur by applying a particular beauty care product. That is, by using the beauty care product, it is believed that the skin undergoes a visual transformation and may become more defined, flawless, and/or luminous, for example.

One exemplary technique for depicting a difference in resolution is to include pixels that are discernable with the naked eye in region 12 and to not include them in region 14 (i.e., region 14 is substantially, but not necessarily completely, devoid of the pixels). As used herein, “pixels” means discrete visual elements that are combinable to form an image. The term “pixels” includes “dots” (e.g., dots formed in dot-matrix created images; dots used in dot-drawings) and other distinct marks as long as they are large enough so as to be discernable with the naked eye. “Individually discernable with the naked eye” means at least some of the pixels are perceivable as discrete visual elements by the eyes of a person having 20/20 vision (corrected or uncorrected) at a distance of one meter without the aid of a magnifying device.

The pixels may vary in shape and size, both within a single image and from image to image. In preferred embodiments, the pixels are square-shaped. But the pixels can have other shapes or geometries, such as, for example, circular, triangular, rectangular, diamond-shaped, oval, and be two-dimensional or three-dimensional. Pixels employed in the present invention preferably have at least one diameter (a straight line segment passing through the center) that is greater than or equal to about 0.01 inch (0.254 mm). Some exemplary pixels in accordance with the present invention include square-shaped elements that have a length and width dimension of about 1/16 inch (1.5875 mm), ⅛ inch (3.175 mm), ¼ inch (6.35 mm), ½ inch (12.7 mm), ¾ inch (19.05 mm) and 1 inch (25.4 mm). Pixels having a diameter larger than 1 inch may also be used, particularly as the size of the overall image increases or the distance between observer and image increases.

The pixels may also vary in color, shade and arrangement, both within a single image and from image to image. The pixels may be achromatic, chromatic, or a combination of the two. Changes in color and/or shade can be used to communicate, or further communicate, a visual transformation in skin appearance. For example, the pixels can transform from a dark shade to a relatively lighter shade to communicate improvement in skin appearance.

The number and arrangement of pixels can vary. In one embodiment, the number of pixels portrayed can represent the number of skin layers a beauty care product is believed or claimed to be capable of penetrating. In this context, the number of pixels portrayed may correlate to penetration textual messages being employed with the image(s). For example, and with reference to FIG. 2, a collection 16 of ten pixels 18 is shown. Note that the pixels vary in shade or color/grayscale intensity. Collections of pixels 18, such as those shown in FIG. 2, may be multiplied and overlayed to provide a three-dimensional appearance (e.g., shown as projecting into or out of the image), as can be seen in FIG. 3. When a plurality of pixels have portions that overlap, distinct boundaries of some of the pixels may become difficult to discern. An observer however, would still perceive the image to contain a plurality of individual pixels in accordance with the present invention.

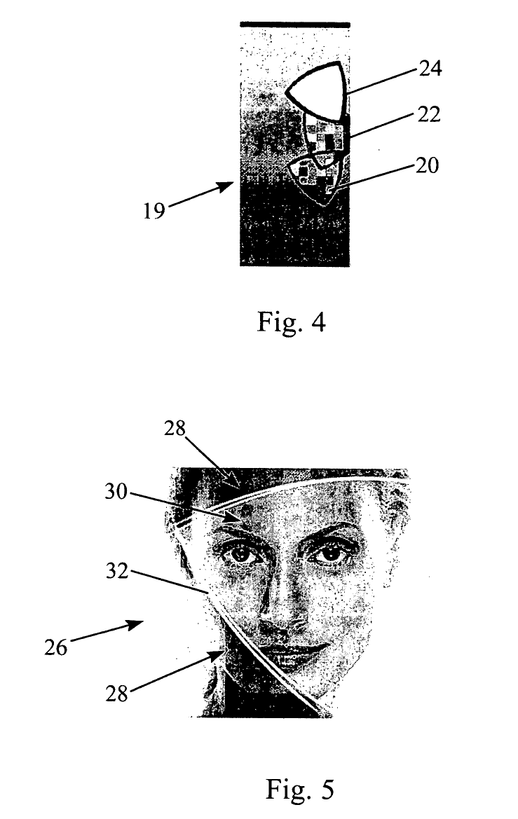

In preferred embodiments, the image being portrayed includes a photograph or an illustration of human skin. Alternative embodiments include an image of a non-skin object, which undergoes a transformation in appearance to communicate or convey the idea of skin going through a similar visual transformation by using an associated beauty care product. By way of example, and with reference to FIG. 4, an image 19 of three interconnecting triangles 20, 22, and 24 is shown. Triangles 20 and 22 contain pixels that are discernable with the naked eye, and triangle 24 does not. The pixels may represent skin imperfections, for example. Thus, triangles 20 and 22 are employed in the image to communicate skin appearance before using an associated beauty care product and/or during initial treatments with the same. Triangle 24 is employed to communicate skin appearance after one or more treatments with the beauty care product. The skilled artisan should readily appreciate that an infinite number of other non-skin images could be used to communicate a transformation in skin appearance.

In one exemplary embodiment, an image is initially pixilated to an extent that the image content is unidentifiable. Over time via a video or other dynamic communication, or through the use of additional still images, the image becomes more defined such that the image content is revealed and readily identifiable. The image content could include, for example, a person (photograph or illustration), an object, a brand name, trademark or other graphic associated with the product.

Other techniques for depicting differences in resolution (e.g., level of clarity or graininess) can be used, including, for example, stippling, halftoning, filtering, image overlaying, and any other known methods for creating a contrast in resolution, focus, or clarity.

A single image defined by two or more regions can also be shaded differently to communicate a visual transformation in skin appearance, rather than using pixels, such as described above. For example, and as shown in FIG. 5, image 26 includes a first region 28 and a second region 30. Second region 30 is portrayed as having a lighter, brighter or illuminated appearance relative to first region 28. The contrast in darkness/lightness again is intended to communicate a visual transformation in skin appearance that may occur by using a particular beauty care product.

The interface of two or more defined regions in a single image can simply be defined by the contrast in their appearance. An example of this is shown in FIG. 1. Alternatively, a partially or completely formed frame may be included to define the interface between the regions of varying resolution or lightness more explicitly. By way of example, a triangular shaped frame 32 is shown in FIG. 5 to define the boundary between first region 28 and second region 30. A single geometrical frame can be used, as well as multiple frames. The frame can vary in size, shape, color, position, arrangement, and visual intensity.

It is to be understood that even though FIGS. 1 and 5 depict images defined by just two regions, three or more regions in a single image can equally be used. When three or more regions are contained in a single image, at least two of the regions should have relatively different levels of resolution or lightness so as to visually communicate a transformation in skin appearance. In preferred embodiments, the number of different levels of resolution or lightness match the number of regions included in the image. When two regions are employed in an image, skin appearance before and after using (single use or repeated uses) a particular beauty care product can be illustrated. When three or more regions are employed in an image, skin appearance before using a beauty care product, after a single use, and after repeated uses can be illustrated, for example. Three or more regions in a single image can also be used to visually convey skin appearance during a transformation from one or more applications of a beauty care product. The skilled artisan should also appreciate that visual contrasts other than resolution/clarity and lightness can be employed to communicate a transformation in skin appearance that may occur by using a particular beauty care product.

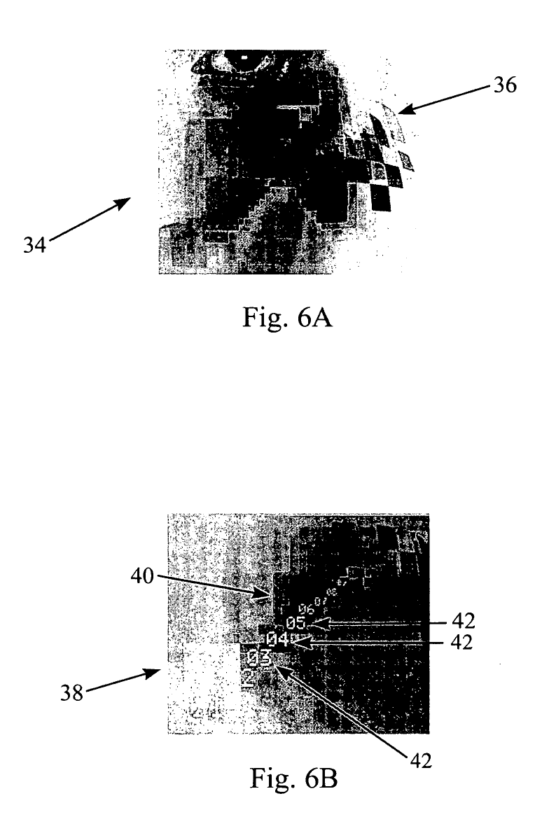

Referring now to FIG. 6A, an image 34 is shown that depicts a portion of human's face and a collection of pixels 36 that appear to be projecting into the skin to visually convey the idea of a beauty care product penetrating beneath the skin's surface. FIG. 6B shows an image 38 that includes a collection of pixels 40 and a series of counting reference characters 42 that may visually convey a penetration level or depth into a user's skin.

In other embodiments of the present invention, multiple images are portrayed to communicate a visual transformation in skin appearance. Each of the multiple images may contain a single level of visual contrast relative to another image, or alternatively contain multiple levels of visual contrast relative to one another within the individual image. When multiple images are used, individual images can be portrayed together or separately (e.g., during a television or an internet advertisement). Preferred embodiments that portray two images are discussed below.

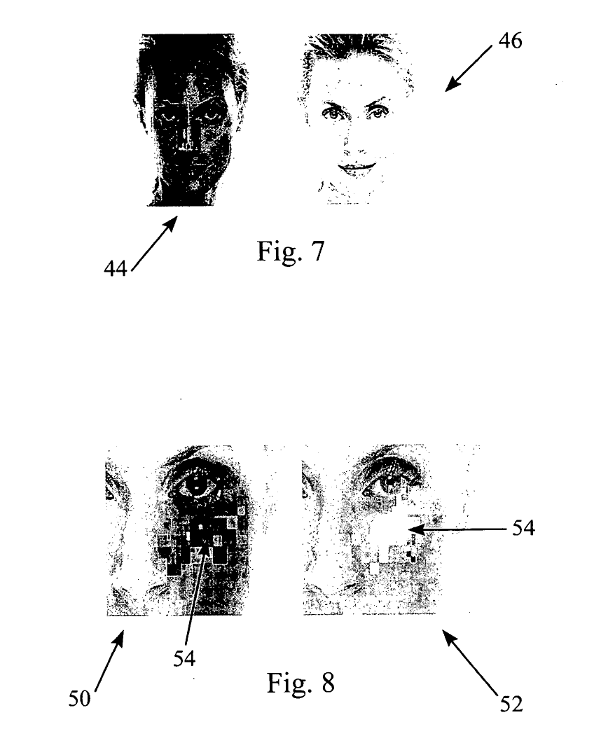

Referring now to FIG. 7, a first image 44 of a woman's face and a second image 46 of the woman's face are shown. Second image 46 appears lighter, brighter or illuminated relative to first image 40. This contrast in lightness is intended to communicate an improvement in skin appearance through use of an associated beauty care product. The contrast in lightness can be accomplished by any known method utilized in photography and/or computer illustrations, for example.

With reference to FIG. 8, a first image 50 and a second image 52 are shown—each of the images depict a portion of a woman's face. First image 50 includes a collection of pixels 54 located in an area under the woman's eye and having a relatively dark shade. Second image 52 depicts the collection of pixels 54 in a relatively lighter shade. The relatively darker shade can represent real or perceived skin imperfections, such as, for example, brown spots, fine lines, wrinkles, or uneven tone. The relatively lighter shade can represent an improvement in appearance of these skin imperfections that may occur by using a particular beauty care product.

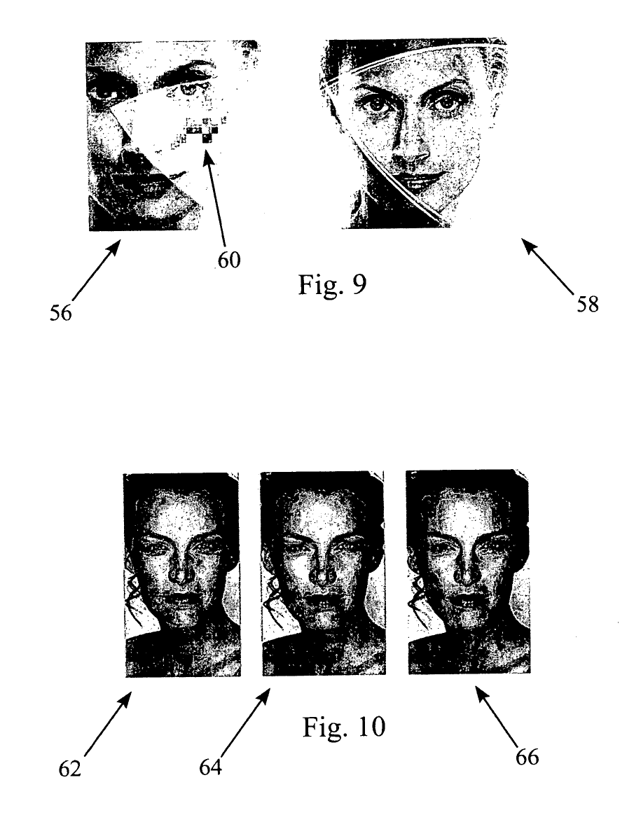

Referring now to FIG. 9, a first image 56 and a second image 58 are shown—each of the images depict a portion of a woman's face. First image 56 includes a collection of pixels 60 and second image 58 is substantially devoid of the pixels 60.

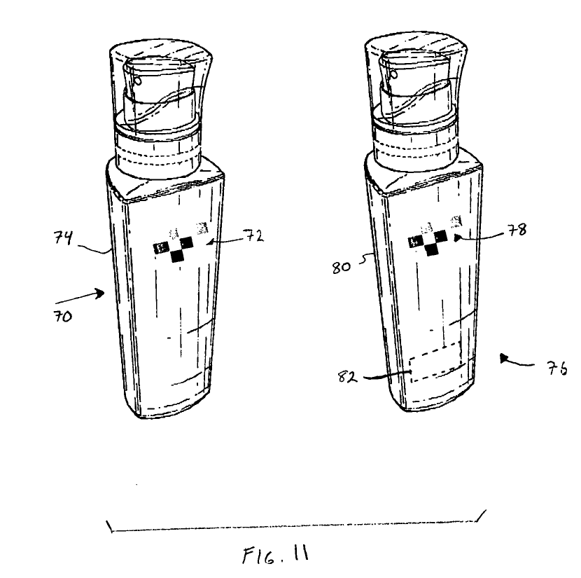

Selling aids and methods of the present invention also include embodiments that portray three or more images. By way of example and with reference to FIG. 10, a trilogy of images is shown, including a first image 62, a second image 64, and a third image 66. First image 62 might be used to communicate skin appearance before using a particular beauty care product, second image 64 might be used to communicate skin appearance after an initial use (or uses) of the beauty care product, and third image 66 might be used to communicate skin appearance after repeated uses of the beauty care product. The images may comprise a photograph (altered or unaltered) of skin, an illustration of skin, or a non-skin illustration. By way of example only, the three images can be depicted as having three levels of increasing resolution or clarity, lightness, brightness or illumination, or other visual attribute amenable to levels of visual contrast. In one preferred embodiment, a first image includes pixels that are discernable with the naked eye, a second image includes the pixels in a relatively lighter shade compared to the first image, and a third image that does not include the pixels. The three images may be portrayed together or separately.

Images of the present invention may be portrayed with or without other communication forms, such as, for example, text and audio. Text can be included in the images, or alternatively, be separate from the images.

The present invention is also directed to methods of merchandising a beauty care product. The methods comprise the step of communicating a comparison between at least two different products. In accordance with one exemplary embodiment, the method comprises the step of communicating to prospective buyers of beauty care products a comparison between a first beauty care product that utilizes pixels discemable with the naked eye on packaging of the first beauty care product and/or in images associated with the sale of the first beauty care product, and a second beauty care product that also utilizes pixels discernable with the naked eye on packaging of the second beauty care product and/or images associated with the sale of the second beauty care product. Referring to FIG. 11, a first beauty care product 70 is shown having a collection of pixels 72 portrayed on the product's primary packaging 74. A second beauty care product 76 is also shown having a substantially similar collection of pixels 78 portrayed on its primary packaging 80. The pixels can be achromatic, chromatic or a combination of the two. The pixels can vary in size, shape, color, shade, arrangement (e.g., overlap, reside adjacent to one another, or be spaced apart from one another). Note that pixels 72 can be similar to or different from pixels 78. The primary packaging 80 of the second beauty care product 76 also has a textual comparison 82 to first beauty care product 70. The information contained in the comparison is unlimited, but preferably should include an identification of the first beauty care product 70. For example, textual comparison 82 may comprise the phrase “compare to” or “compare with” followed by the brand name (or other recognizable identifier) of the first beauty care product. Additional product comparisons may include use benefits or consumer groups to which each of the products are targeted. Comparisons may be made via other communicative vehicles other than the primary packaging, such as, for example, advertisements, brochures, product displays, and coupons.

Additional exemplary embodiments include comparisons between a first beauty care product that utilizes pixels discemable with the naked eye on packaging of the first beauty care product and/or in images associated with the sale of the first beauty care product, and a second beauty care product that does not utilize the pixels. In another embodiment, one or more triangles are used in place of pixels. In yet another embodiment, pixels and one or more triangles are used by one or both of the first and second beauty care products. Other geometrical shapes can also be used besides triangles, including a combination of different geometrical shapes.

All documents cited in the Detailed Description of Illustrative and Preferred Embodiments are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for facilitating the selling of a beauty care product, comprising the step of communicating to consumers a visual transformation in skin appearance from a first appearance before using the beauty care product to a second appearance after using the beauty care product, wherein the visual transformation is depicted through the use of pixels, at least some of the pixels being individually discernable with the naked eye.

2. The method of claim 1, wherein the method comprises portraying a first image or image region comprising a plurality of pixels and a second image or image region, wherein in the second image or image region the plurality of pixels are changed in appearance relative to the first image or image region.

3. The method of claim 1, wherein the first appearance and the second appearance are portrayed in a single image.

4. The method of claim 1, wherein the first appearance and the second appearance are portrayed in two or more images.

5. The method of claim 1, comprising the step of portraying a skin image comprising a plurality of pixels that appear to be projecting into or out of the skin image to communicate a transformation in skin appearance through use of the beauty care product.

6. The method of claim 1, comprising the steps of:
a) portraying a first image or image region to communicate skin appearance before using the beauty care product, the first image or image region comprising a plurality of pixels that are discernable with the naked eye and that have a first shade; and
b) portraying a second image or image region to communicate the skin appearance after using the beauty care product, the second image or image region comprising the plurality of pixels having a second shade that appears relatively lighter than the first shade.

7. The method of claim 6, wherein each of the first image or image region, and the second image or image region comprises a photograph of skin and/or an illustration of skin.

8. The method of claim 6, wherein each of the first image or image region, and the second image or image region comprises a non-skin illustration.

9. The method of claim 1, comprising the steps of:
a) portraying a first image or image region to communicate skin appearance before using the beauty care product, the first image or image region comprising a plurality of pixels that are discemable with the naked eye; and
b) portraying a second image or image region to communicate the skin appearance after using the beauty care product, wherein the second image or image region is substantially devoid of the plurality of pixels.

10. The method of claim 9, wherein each of the first image or image region, and the second image or image region comprises a photograph of skin and/or an illustration of skin.

11. The method of claim 9, wherein each of the first image or image region, and the second image or image region comprises a non-skin illustration.

12. A method for facilitating the selling of a beauty care product, comprising the steps of:
a) portraying a first image or image region to communicate skin appearance before using the beauty care product; and
b) portraying a second image or image region to communicate skin appearance after using the beauty care product,
wherein the second image or image region appears to have a relatively higher resolution or clarity than the first image or image region.

13. The method of claim 12, wherein each of the first image or image region and the second image or image region comprises a human face.

14. A method for facilitating the selling of a beauty care product, comprising the steps of:
a) portraying a first image or image region to communicate skin appearance before using the beauty care product; and
b) portraying a second image or image region to communicate skin appearance after using the beauty care product, wherein the second image or image region appears brighter, lighter or illuminated relative to the first image or image region.

15. The method of claim 14, wherein each of the first image or image region and the second image or image region comprises a human face.

16. A method for facilitating the selling of a beauty care product, comprising the steps of:
a) portraying a skin appearance image associated with a human body part; and
b) distinguishing a first portion of the skin appearance image from a second portion of the skin appearance image by including a geometrical shape with the skin appearance image, wherein the first portion is substantially within the boundaries of the geometrical shape and the second portion is substantially outside the boundaries of the geometrical shape, and wherein the first portion has a different appearance than the second portion.

17. The method of claim 16, wherein the geometrical shape comprises a triangle or a portion of a triangle.

18. The method of claim 16, wherein the first portion is relatively lighter in appearance than the second portion.

19. The method of claim 16, wherein the first portion appears to have a relatively higher resolution than the second portion.

20. The method of claim 16, wherein the first portion appears illuminated relative to the second portion.

21. The method of claim 16, wherein the human body part is selected from the group consisting of face, chest, neck, and hand.

22. A method for facilitating the selling of a beauty care product, comprising the steps of:
a) portraying a first image to communicate skin appearance before using the beauty care product;
b) portraying a second image to communicate the skin appearance following a single use of the beauty care product; and
c) portraying a third image to communicate the skin appearance following repeated uses of the beauty care product.

23. A beauty care product selling aid, comprising:
a) a tangible medium of expression;
b) two or more images fixed in the tangible medium of expression and portrayable via the tangible medium of expression, the two or more images depicting a visual transformation in skin appearance from a first appearance before using the beauty care product to a second appearance after using the beauty care product, wherein the visual transformation is depicted through the use of pixels, at least some of the pixels being individually discernable with the naked eye.

24. The beauty care product selling aid of claim 23, wherein one of the two or more images comprises the pixels and the other of the two or more images is devoid of the pixels.

25. The beauty care product selling aid of claim 23, wherein the pixels have a first shade in one of the two or more images and the pixels have a second shade that appears lighter relative to the first shade in the other of the two or more images.

26. A beauty care product selling aid, comprising:
a) a tangible medium of expression; and
b) a trilogy of skin appearance images fixed in the tangible medium of expression and portrayable via the tangible medium of expression, the trilogy of skin appearance images comprising:
i) a first image to communicate skin appearance before using a beauty care product;
ii) a second image to communicate skin appearance after an initial use or uses of the beauty care product; and
iii) a third image to communicate skin appearance after repeated uses of the beauty care product.

27. A beauty care product selling aid, comprising:
a) a tangible medium of expression;
b) a skin appearance image associated with a human body part fixed in the tangible medium of expression; and
c) a geometrical frame fixed in the tangible medium of expression and associated with the skin appearance image, the geometrical frame defining a first image portion within the boundaries of the geometrical frame and a second image portion outside the boundaries of the geometrical frame.

28. The beauty care product selling aid of claim 27, wherein the geometrical frame is triangular.

29. The beauty care product selling aid of claim 27, wherein the first image portion is relatively lighter in appearance than the second image portion.

30. The beauty care product selling aid of claim 27, wherein the first image portion is relatively brighter in appearance than the second image portion.

31. The beauty care product selling aid of claim 27, wherein the first image portion appears to have a higher resolution relative to the second image portion.

32. The beauty care product selling aid of claim 27, wherein the first image portion appears illuminated relative to the second image portion.

33. The beauty care product selling aid of claim 27, wherein the human body part is selected from the group consisting of face, chest, neck, and hand.
